(19) United States
(12) Patent Application Publication
(10) Pub. No.: US 2006/0207774 A1
(43) Pub. Date: Sep. 21, 2006

(54) Fire fighting helicopter

(76) Inventor: Roger Payassis, Limassol (CY)

Correspondence Address: KENYON & KENYON LLP, 1500 K STREET N.W., SUITE 700, WASHINGTON, DC, 20005, US

(21) Appl. No.: 10/566,587

(22) PCT Filed: Aug. 5, 2004
(86) PCT No.: PCT/CY04/00004

§ 371 Date: Jan. 31, 2006

(51) Int. Cl. A62C 27/00; A62C 25/00; A62C 29/00

(52) U.S. Cl. 169/53; 169/52

(57) ABSTRACT

This invention provides a fire fighting Helicopter of the type which includes in the fuselage (2) tanks (3) filled with fire fighting fluid for putting out fires. The fire fighting Helicopter has a launcher for the fire fighting fluid under pressure and is found in the front lower part of the pilot's deck. The fire fighting Helicopter is also characterised for the fact that a plate (14) in the main tank of the fire fighting fluid is moving up and down vertically so that the fluid is kept stable between the main tank and the side walls of the main tank and in this way the centre of gravity is stable.

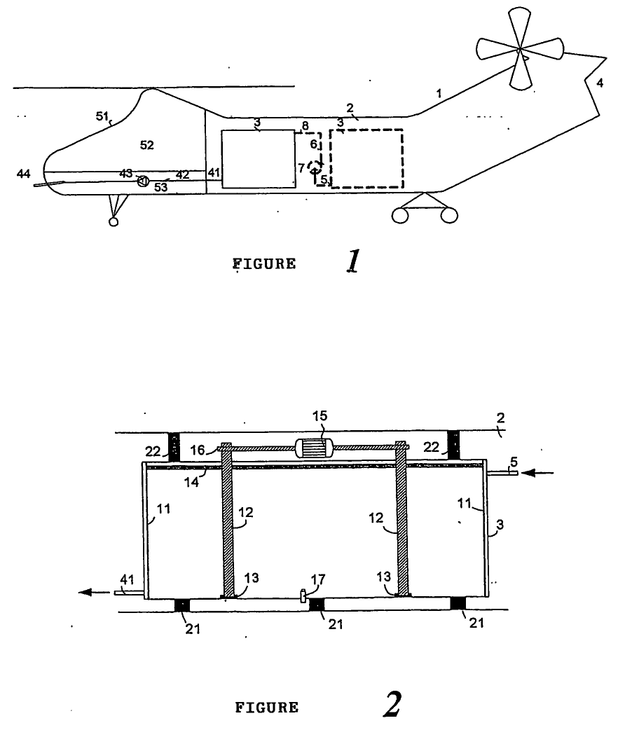

The present invention refers to a means of fire fighting and the confrontation of fires, particularly the fires in inaccessible areas, as in forests. More specifically it refers to an improved fire-fighting helicopter.

A serious problem, that fire fighting forces face, for the extinguishing of fire in a forest, is the lack of accessible roads. This causes delays in the intervention of fire fighting personnel and allows the fire to spread beyond its initial hearth; therefore its confrontation is worsened.

For the confrontation of the problem of lack of access to the fire front, flying means have been used, like planes and helicopters. The first, because of their construction, can only make a rapid passage above a hearth of fire and thus can only vacate certain and if possible a large, quantity of water in a specific point of the fire front. This is costly, as far as the water and time is concerned; as the plane should immediately return for supply and come back for a new drop in another point ahead, and so on. Furthermore, there are dangers for the personnel that work on the ground from the drops.

The helicopters that are used for fire fighting usually transport a large bucket full of water, which is hanging under the helicopter. During the operation, the captain selects the expedient point, immobilises the helicopter and vacates the bucket. This allows the more sensible management of water, as the point of drop can be selected with more accuracy and the aiming to be more precise.

Another notable problem is the problem of stability of flight. At the abrupt evacuation of water from the bucket, the centre of gravity of the plane is shifted instantaneously, because of the principle of maintenance of impetus, and therefore the abilities of handling by the pilot are required for the safe governing of the plane. Also, during manoeuvres, unanticipated shifts of centre of gravity of aquatic mass are observed that can set at risk the safety of flight and in order to be faced require particular abilities of the pilot.

The present invention resolves at least a few of the problems mentioned above, providing a fire fighting helicopter which allows the systematic and precise drop of fire fighting liquid where and when it is required.

The present invention also resolves the problem of instability of flight because of shifts of centre of gravity of fire fighting liquid.

Therefore, according to the present invention, a fire fighting helicopter is provided which includes in its fuselage reservoirs of fire fighting liquid, characterized by that it includes a launcher of fire fighting liquid under pressure in the front lower deck of fuselage for the controlled launch of fire fighting liquid. Also, a plate in the main reservoir tank of the fire fighting liquid is vertically moving between steady drivers so that it always maintains the quantity of fire fighting liquid inside the reservoir in steady state between solid walls and it avoids the movement of its centre of gravity.

According to a preferred realisation of invention, the front deck of the helicopter is divided vertically in two decks, the upper section constitutes the cockpit and the lower has sufficient space in order to accept an operator who handles the nozzle fire fighting liquid.

Preferably, according to the invention, the extra plate in the main reservoir of fire fighting liquid is shifted vertically with the help of two vertical worm screws run from an electric motor.

The invention will be described more in detail below with reference to the attached drawings, in which:

Drawing 1 is a schematic side view section of a fire-fighting helicopter according to the invention

Drawing 2 is a side view (section) of the main reservoir of fire fighting liquid of helicopter according to the present invention

In drawing 1 there is a helicopter 1 of a type that can be used for the application of the present invention. The fuselage 2 of helicopter 1 is shaped in such a way that it accepts one or two parallelepiped reservoirs 3 for accepting fire fighting liquid, depending on the size and power of the helicopter. At the rear end of the helicopter there is loading access 4 which allows the loading and the unloading of reservoir (or the reservoirs) of fire fighting liquid when the helicopter is preparing for the operation.

The main reservoir 3, which will be described in more detail below, has a general form of a parallelepiped rectangle and it is supported on the flooring of the fuselage of the helicopter via six pads 21 (drawing 2) placed in the four edge base of the main reservoir and in the middle of two across edges. Also, for the complete immobilisation of the main reservoir, four wedges 22 (drawing 2) which are placed between the roof of reservoir 3 and the fuselage 2, in the four corners of the surface of the roof of reservoir 3.

If a second reservoir is also used, this has a similar form with the main reservoir, it is placed behind this, with reference to the line of movement of the helicopter, and it is placed and immobilised with the same way as the main reservoir. In a place of the front side of the second reservoir, near the bottom of the reservoir, there is a departing exit of liquid 5 closing with an interrupting valve. When the second reservoir is placed and immobilised inside the helicopter, departing exit 5 is connected via a flexible pipe 6, and with the interjection of pump 7, with a stand-by entry of liquid 8, which is forecasted in a place in the rear side of the main reservoir, near the roof of the main reservoir.

As already mentioned, and as it appears in drawing 2, the main reservoir 3 has the form of a rectangle parallelepiped. In the interior, and near the four vertical edges, four vertical linear sliding guides 11 are forecasted. In the across level of symmetry of the main reservoir and symmetrically placed for the traverse level of symmetry two worm screws 12 are placed. These screws 12 are supported in rotation position 13 in the flooring of reservoir. The worm screws 12 penetrate the roof of the reservoir 3 via waterproof rotation positions and terminate in small height above the roof of the main reservoir 3.

Also in the internal main reservoir 3, and parallel to the roof and its flooring, a metal plate of restriction 14 with dimensions equal to the internal dimensions of the ground plan of the main reservoir, is forecasted. The plate of restriction 14 slides freely with the help of suitable means inside the four linear guides of slipping 11, while perimetrically its tolerances concerning the adjacent surfaces of the reservoir are minimally possible, so that it ensures the leak-tightness between its upper and lower side of the restriction plate.

In the across axis of the metal plate of restriction 14 and in places that correspond to those of worm screws 12, two holes are opened up. The holes have an internal coil that corresponds to the level, the geometric form and dimensions of those of the worm screws 12, so that they collaborate with them.

On the roof of the reservoir and around its centre an electric motor 15 is installed, whose rotating rods 16 are horizontal and stick out both sides from the two ends of the motor 15 and ends in screws collaborating with their worm screws 12 in such a way that they turn the rotating movement around the horizontal axis into a rotating movement around the vertical axis and with the direction of the worm screws 12. This rotating movement of worm screws 12 is changed into a straight movement of slipping, rise or fall depending on the direction of rotation of worm screws 12, plate 14 along the sliding guides 11, via the coil holes of the plate of restriction 14. Also on the roof of reservoir 3, in the preferred position there is a box of inspection. Finally, in a suitable point of the bottom of the main reservoir of 3, a sensor switch 17 of any suitable type is placed.

In the front side and near the bottom of the main reservoir there is a nozzle for the exit of fire fighting liquid 41. This is connected via a flexible pipe 42 and with the interjection of a high pressure pump 43 with a launcher nozzle of high pressure 44 placed in the front lower deck of the helicopter, as it appears in picture 1. Launcher 44 is assembled with freedom of movement so that it can be directed manually on the desirable target and is regulated in such a way that the water can be ejected or sprayed concentrated.

The front department 51 of the helicopter is divided with a horizontal flooring in an upper and lower deck. Upper deck 52 is occupied by a classical helicopter cockpit. This helicopter cockpit is known in the trade and will not be described in more detail here.

The lower deck 53, includes the launcher of fire fighting liquid 44, is of small height and it has such dimensions that it can accept an individual in a lying position. This deck constitutes the handling position of the launcher. It communicates with the upper deck via a trapdoor, by which the operator can descend and occupy the handling position of the launcher. The front half of the lower deck is transparent in order to allow the operator to observe the ground of the fire, and select the target and direct the launcher.

The lower deck also contains a handling board with switches to operate the plate 14, via an electric motor 15 and limit switch 17. This handling board is suitably placed so that it can be used easily by the operator of the launcher and can include, for example:

a) a control of the descend of the plate

b) a control of immobilisation of the motor

c) a control of the rise of the plate

d) a control of cancellation of the operation of controls a) to c) and transfer of control of rise-fall of plate 14 on limit switch 17.

During the preparation of the helicopter for a venture, the electric motor of shift of plate of restriction is placed in operation so that it raises the plate of restriction in its upper place, almost in contact with the roof of the main reservoir. In this way, the waiting entry of the main reservoir is placed in operation with the interior of the main reservoir and it allows its filling with fire fighting liquid, via the second reservoir and the pump, if they are forecasted (if a second tank exists).

During the extinguishing of the fire, the operator uses launcher 44 for the launch of fire fighting liquid in the suitable places and quantities, contrary to the usual practice of dropping of big quantities in one only point. While the fire fighting liquid is consumed and as the level inside the main reservoir descends, the electric motor of main reservoir is placed once again in operation affecting the descent of the plate of restriction, so that the free surface of fire fighting liquid is always in contact with the lower side of the plate of restriction. In this way, movements of the free surface during manoeuvres of the helicopter is restricted and therefore shifts of the centre of gravity that can cause instability of the flight are avoided. When the plate of restriction approaches the bottom of the reservoir, the limit switch is activated and it deactivates the operation the electric motor.

The invention was described above according to a preferred way of realisation. It is however obvious that the experts of the profession can use various changes in the particular used technical means or replace them with other equivalent ones. All these changes and modifications are covered by the invention, which is limited only by the frame of the attached claims.

1-3. (canceled)

4. A fire fighting helicopter of the type that includes in the fuselage reservoirs of the fire fighting liquid for the extinguishing of fire, which includes a launcher for controlling the quantity of the fire fighting liquid under pressure, wherein the launcher is set in the front of a lower deck and a restriction plate in a main reservoir of fire fighting liquid is vertically mobile between stable guides, so that it always restricts the quantity of fire fighting liquid that is inside the reservoir stable between solid walls, avoiding in this way the movement of its center of gravity.

5. A fire fighting helicopter according to claim 4, wherein the front section of the fuselage of the helicopter is vertically divided in two decks from which the upper constitutes the cockpit and the lower which has sufficient space in order for it to receive in lying position an operator who operates the launcher of the fire fighting liquid, and also controls the direction of the said launcher.

6. A fire fighting helicopter according to claim 4, wherein the restriction plate of the main reservoir of the fire fighting liquid is shifted vertically with the help of two vertical, worm screws operated by an electric motor.

7. A fire fighting helicopter according to claim 5, wherein the restriction plate of the main reservoir of the fire fighting liquid is shifted vertically with the help of two vertical, worm screws operated by an electric motor.
